(19) United States
(12) Patent Application Publication
(10) Pub. No.: US 2026/0370482 A1
(43) Pub. Date: Nov. 19, 2026

(54) COMPOSITE ZERO-KNOWLEDGE PROOF SYSTEM FOR VERIFIABLE, ADVERSARIALLY SECURE GAME EXECUTION

(71) Applicant: Brandon David Anderson, Scottsdale, AZ (US)

(72) Inventor: Brandon David Anderson, Scottsdale, AZ (US)

(73) Assignee: Molten Dice Inc, Scottsdale, AZ (US)

(21) Appl. No.: 19/550,188

(22) Filed: Feb. 25, 2026

Related U.S. Application Data
(60) Provisional application No. 63/762,660, filed on Feb. 25, 2025.

(51) Int. Cl. H04L 9/32; A63F 1/00; H04L 9/00

(52) U.S. Cl. CPC H04L 9/3221; A63F 1/00; H04L 9/50; A63F 2001/008

(57) ABSTRACT

A composite zero-knowledge proof system enables adversarially secure execution of games with verifiable randomness and privacy-preserving hidden state. A deck or other private game inputs are verified in a zero-knowledge virtual machine (ZKVM) against a public ownership commitment, producing a commitment to the private inputs without revealing them. Adversarial parties generate a composite random seed via commit-reveal or multi-party entropy such that no single party controls the outcome. A ZKVM executes a verifiable shuffle to produce a shuffled commitment and a shuffle proof attesting to a valid permutation. Draws and other hidden-information reveals generate proofs that revealed values correspond to committed positions. Game moves are proved as correct state transitions and may be aggregated recursively for efficient verification and settlement.

### CROSS-REFERENCE TO RELATED APPLICATIONS

This application claims the benefit of U.S. Provisional Patent Application No. 63/762,660, filed Feb. 25, 2025, entitled “Composite Zero-Knowledge Proof System for Verifiable, Adversarially Secure Game Execution,” the disclosure of which is incorporated herein by reference in its entirety.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### STATEMENT REGARDING PRIOR DISCLOSURES BY AN INVENTOR OR JOINT INVENTOR

Not applicable.

### BACKGROUND OF THE INVENTION

### Field of the Invention

The invention relates to cryptographic protocols and computer-implemented systems for executing game logic with verifiable randomness and privacy-preserving hidden state, including use of zero-knowledge proofs and zero-knowledge virtual machines to validate adversarial state transitions in decentralized or distributed gaming.

### Description of Related Art

Online multiplayer games typically rely on a trusted centralized server to (i) accept player inputs, (ii) compute game state transitions, (iii) generate random outcomes (for example, shuffles, dice rolls, loot drops), and (iv) enforce rules to prevent cheating. In conventional networked computing, client devices are untrusted; therefore, absent a trusted server, adversarial players can manipulate local state, network messages, or randomness sources to obtain unfair advantages.

Decentralized games have decentralized asset ownership by recording items, cards, and other game assets on a distributed ledger using token standards (for example, ERC-20, ERC-721, and ERC-1155). However, most such games still execute game logic off-chain in centralized servers, so fairness and rule enforcement remain dependent on a trusted intermediary.

Games involving hidden information and randomness, including trading card games (TCGs), collectible card games (CCGs), and other adversarial games, require that (i) a deck be composed of owned assets and meet deck-building constraints, (ii) a deck be shuffled fairly without allowing any participant to bias or predict the outcome, and (iii) cards be drawn and revealed only at permitted times. Conventional commit-reveal approaches and verifiable random functions (VRFs) can reduce trust but still allow practical cheating vectors such as selective aborts, prediction of future RNG outputs once a seed is known, or reliance on external randomness providers.

Zero-knowledge proofs enable a prover to convince a verifier that a computation was performed correctly without revealing private inputs. Zero-knowledge virtual machines (ZKVMs) extend this by proving correct execution of general-purpose programs. Nonetheless, existing approaches do not fully address (i) adversarially fair randomness generation, (ii) privacy-preserving deck and hand management, and (iii) efficient verification of a long sequence of game moves in a decentralized settlement environment.

Accordingly, there remains a need for systems and methods that enable verifiable, adversarially secure game execution with hidden information and randomness, without reliance on a centralized authority, and with proofs that can be efficiently verified and settled on a distributed ledger.

### BRIEF SUMMARY OF THE INVENTION

Disclosed is a composite zero-knowledge proof system that enables adversarial participants to execute a game while providing verifiable fairness, privacy of hidden game state, and verifiable randomness. The system combines (i) asset ownership verification anchored to an on-chain or otherwise shared state commitment, (ii) commit-reveal or multi-party randomness generation producing a composite seed that no single party controls, (iii) verifiable shuffle and draw protocols executed within a zero-knowledge virtual machine, (iv) progressive reveal of hidden elements at authorized times, and (v) proof composition and optional recursive aggregation for efficient settlement.

In certain embodiments, deck composition is validated without revealing deck contents by proving in zero knowledge that a proposed deck is a subset of a player's owned assets and satisfies deck-building constraints, and by outputting a deck commitment bound to a canonical ordering and per-card commitments.

In certain embodiments, randomness for shuffle and other stochastic events is produced by combining two or more independently committed seed components into a composite seed using a deterministic, commutative function (for example, XOR, addition modulo a field, or hashing of concatenated seed components), with timeouts and forfeiture conditions that deter selective aborts.

In certain embodiments, shuffling is executed in a ZKVM that proves a valid permutation of committed inputs under the composite seed. For shared-deck games where no single party should learn the final deck order, cards may be encrypted under a threshold key and shuffled via verifiable re-encryption shuffles (mixnet style), with threshold decryption performed only for revealed positions.

In certain embodiments, each game move is executed as a ZKVM program that consumes prior state commitments and action commitments and outputs a next state commitment and a proof of correct state transition. Multiple proofs may be aggregated recursively to enable low-cost on-chain verification and final settlement.

### BRIEF DESCRIPTION OF THE SEVERAL VIEWS OF THE DRAWINGS

FIG. 1 is a block diagram illustrating the overall system architecture, including player computing systems, a zero-knowledge virtual machine runtime with functional modules, a distributed ledger, and a verifier smart contract.

FIG. 2 is a flowchart illustrating a deck composition verification process, including ownership validation via Merkle inclusion proofs, ruleset constraint evaluation, and deck commitment computation.

FIG. 3 is a sequence diagram illustrating a commit-reveal seed component protocol between two or more parties, including seed component generation, peer-to-peer commitment exchange, verification, composite seed computation, and timeout forfeit rules.

FIG. 4 is a data flow diagram illustrating a known-order shuffle execution within a ZKVM program, showing inputs of a committed deck representation and composite seed, internal cryptographically secure pseudorandom number generator (CSPRNG) initialization and Fisher-Yates permutation, and outputs of a shuffled deck commitment and shuffle proof.

FIG. 5 is a multi-phase data flow diagram illustrating a split-knowledge commitment protocol, including Phase 1 where a deck owner generates per-position commitments and canonical sorting, Phase 2 where an adversary shuffler applies a Fisher-Yates shuffle to commitments using a composite seed, and Phase 3 where a draw and reveal operation verifies commitment openings, with annotations showing the seed component disclosure pattern that preserves split-knowledge.

FIG. 6 is a block diagram illustrating a progressive reveal and draw operation, including a decision branch between commitment-based opening and threshold decryption paths, converging to a revealed card value and reveal proof.

FIG. 7 is a block diagram illustrating a game state transition process and recursive proof aggregation, showing a prior state commitment and player action as inputs to a ZKVM state transition program producing a next state commitment and transition proof, with a recursive aggregator combining multiple proofs into an aggregate proof for on-chain settlement.

FIG. 8 is a schematic diagram illustrating an on-chain asset ownership Merkle tree, showing ledger token balances as leaf nodes, intermediate hash nodes, a Merkle root, and an inclusion proof path.

FIG. 9 is a sequential block diagram illustrating a shared-deck multi-party encryption protocol, including threshold encryption, sequential re-encryption shuffles by each party with per-party shuffle proofs, and an encrypted deck commitment.

FIG. 10 is a data flow diagram illustrating PRNG stream segmentation and non-deck randomness, showing a composite seed initializing a CSPRNG whose output stream is consumed by multiple proofs (shuffle, dice roll, loot drop), and a separate per-asset seed derivation via domain-separated XOR of global entropy and a hashed asset identifier.

FIG. 11 is a schematic diagram illustrating an example computing environment, including a computing device with processors, memory, a network interface, and non-transitory storage, connected to a distributed ledger node.

### DETAILED DESCRIPTION OF THE INVENTION

### 1. Definitions

Adversarial actor: a participant whose inputs may be biased toward a preferred outcome and therefore must be accounted for in fairness and soundness guarantees.

Card: a digital game element representing an asset, such as a token identifier or value used as an input to game logic.

Deck: an ordered collection of cards used in gameplay, optionally represented in a canonical order for verifiable operations.

Ruleset: a machine-readable identifier and associated constraint parameters specifying allowed deck composition, allowed actions, and state transition constraints for a particular application.

Canonical order: a predetermined deterministic ordering applied to a set of elements to enable consistent commitments and proofs.

Commitment: a cryptographic binding to a value that is hiding and binding, such as a hash commitment, Pedersen commitment, or other commitment scheme.

Opening secret: a secret value used to open a commitment and prove the committed value matches a revealed value.

Seed component: an individual party's contribution to a composite seed. A seed component commitment is a commitment to a seed component generated by a participant. A seed component, or a digest thereof, may be exchanged between parties or disclosed in a proof journal.

Composite seed: a seed computed from two or more seed components using a deterministic and commutative combination function, such that no single party controls the outcome. Protocol verification does not require disclosure of the composite seed.

Random number generator: a cryptographically secure generator used to derive unbiased indices or values from a seed (for example, ChaCha20-based stream generation, a sponge construction, or a hash-based PRNG).

Zero-knowledge proof: a proof that a statement is true without revealing additional information beyond validity.

Zero-knowledge virtual machine: a system that executes a program and produces a proof attesting to correct execution of the program with respect to specified public inputs and outputs.

Deck commitment: a commitment computed from the deck representation and associated salts or opening secrets, serving as an immutable fingerprint of deck composition and ordering.

Draw operation: a protocol that selects and reveals a card associated with a particular deck position, accompanied by a proof that the revealed card corresponds to the committed deck.

Interactive composite zero-knowledge proof: a proof construction in which multiple parties contribute commitments or partial proofs such that the final proof depends on interdependent contributions and no single party can unilaterally bias the proved outcome.

Recursive proof aggregation: a technique that combines multiple proofs into a single proof, enabling efficient verification of a sequence of operations (for example, a sequence of moves in a game).

Distributed ledger network: a blockchain or similar replicated state machine supporting verifiable state commitments and, in some embodiments, smart contract verification of proofs.

Public ownership commitment (also referred to as an ownership root, ownership Merkle root, or distributed-ledger state root): a compact cryptographic commitment to the ownership state used to anchor verification of asset ownership, such as a Merkle root over token balances or a state root obtained from a distributed ledger.

Private game-input data—Data held by a party that is concealed from one or more other parties and that determines or influences game outcomes when processed by the cryptographic game-execution protocol. The validity of private game-input data is attested by one or more zero-knowledge proofs without requiring disclosure of the data itself. Private game-input data may be selectively disclosed during gameplay (for example, when a card is drawn, an asset is used, or a hidden region is revealed) or may remain concealed indefinitely. Private game-input data includes, but is not limited to, card values defining a deck, token identifiers representing owned assets, dice parameters, hidden inventory contents, fog-of-war state, or other inputs to a game-execution process whose correctness is verifiable without disclosure.

### 2. Overview and System Architecture

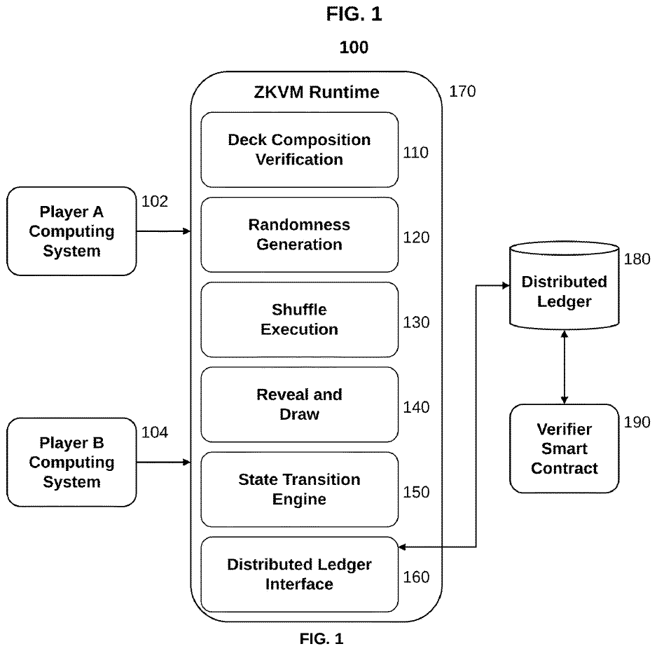

FIG. 1 illustrates an example system (100) that enables adversarially secure game execution. The system may include player computing systems (102, 104), a prover node executing a ZKVM runtime (170), and a distributed ledger network (180) including a verifier smart contract (190). In some embodiments, one or more participants operate prover nodes; in other embodiments, a neutral prover service generates proofs subject to public verifiability. In certain embodiments, the system operates in a peer-to-peer configuration in which player computing systems exchange proofs directly, and each device includes a local verifier that independently verifies received proofs without recording to a distributed ledger.

In the example of FIG. 1, the ZKVM runtime (170) executes one or more programs implementing modules including a deck composition verification module (110), a randomness generation module (120), a shuffle execution module (130), a progressive reveal and draw module (140), a game state transition engine (150), and a distributed ledger interface (160). These modules may be implemented as separate programs, libraries, circuits, or instruction sequences executed within a ZKVM or within one or more proving systems.

The distributed ledger interface (160) may query and update on-chain commitments (for example, an ownership Merkle root, a game-state commitment, or proof verification results) and may submit proofs to the verifier smart contract (190). The verifier smart contract (190) verifies the proof(s) and updates on-chain game state, escrowed assets, or settlement outputs.

### 3. Distributed Ledger Asset Tracking and Ownership Commitments

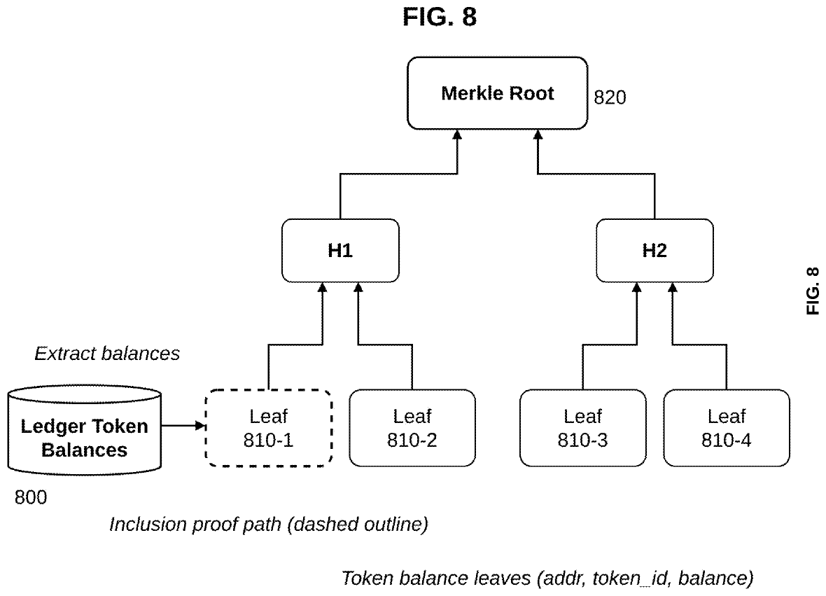

FIG. 8 illustrates an example asset ownership commitment scheme. In one embodiment, player-owned game assets are represented as ledger-managed token balances (800), such as ERC-1155 balances keyed by (address, token_id). A Merkle tree over relevant balance entries is constructed, and a Merkle root (820) represents a compact commitment to the ownership state. The root may be obtained from on-chain storage, from a light-client proof, or from a rollup state root.

In an alternative embodiment, ownership is proven using ledger “view records” or state proofs obtained from a node or light client, including account proofs, storage proofs, or transaction receipts, and the ZKVM verification program validates that the provided view records are consistent with a block header or state root that is publicly committed on the distributed ledger.

In a further embodiment, the ownership-proving party demonstrates control of the private key associated with the account from which the view record was generated. The system retrieves the block hash for the block containing the view call and requires the ownership-proving party to produce a digital signature over the block hash or a nonce derived therefrom. The ZKVM verification program validates the signature against the account's public key, cryptographically binding the ownership claim to the account without disclosing the account's identity. The resulting proof attests that the ownership data is authentic, that the view record is anchored to a specific block, and that the proving party controls the corresponding private key.

In an embodiment, a deck is represented as a list of token identifiers in canonical order. For each deck element, the player provides a Merkle inclusion proof from the corresponding leaf (810-1 through 810-4) to the root (820), proving the element is owned in sufficient quantity. Deck legality constraints (for example, minimum and maximum deck size, per-card copy limits, or format restrictions) may be proved within a ZKVM program using private deck contents and public rule parameters.

To preserve privacy, the system outputs only a deck commitment bound to the private deck contents and, in some embodiments, to per-card commitments. The deck commitment may be computed as a collision-resistant hash of (deck elements in canonical order, per-element salts or opening secrets, and a deck-level salt).

### 4. Deck Composition Verification

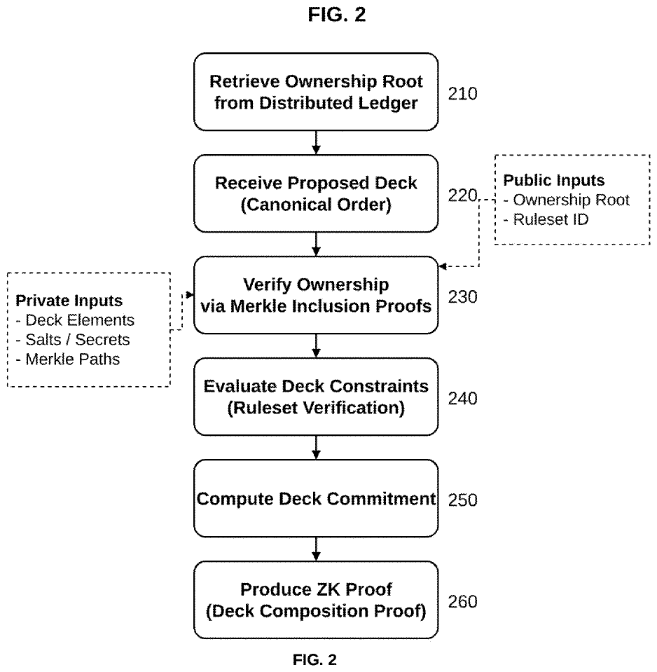

FIG. 2 illustrates an example deck composition verification workflow. At step (210), the module retrieves or accepts a public ownership root. At step (220), the player provides a proposed deck in canonical order. At step (230), the module verifies that each proposed element is owned, using Merkle inclusion proofs anchored to the ownership root, optionally including balance proofs for multiple copies. At step (240), the module evaluates deck constraints according to game rules or a ruleset commitment. At step (250), the module computes a deck commitment. At step (260), the ZKVM produces a proof attesting to the above checks while keeping deck contents private.

In one embodiment, the public inputs to the deck-verification proof include the ownership root, a ruleset identifier or ruleset commitment, and the resulting deck commitment. The private inputs include the deck elements, salts, and Merkle paths. This separation improves the integrity of decentralized game execution by enabling on-chain enforcement without revealing deck composition.

In an alternative embodiment, deck verification is performed without an ownership proof. In such an embodiment, the deck verification program receives a ruleset identifier as a public input and receives a candidate plurality of card values and associated openings as private inputs, verifies that the card values satisfy deck-building constraints of the ruleset (for example, deck size bounds, per-card copy limits, and format restrictions), and outputs a deck commitment and a zero-knowledge deck composition proof, without verifying ownership of the card values against a distributed ledger or other external state root. This embodiment is applicable to games in which decks are composed from a universally available set of elements, from ephemeral assets not recorded on a distributed ledger, or from any context in which ruleset compliance rather than asset ownership is the relevant constraint.

### 5. Adversarially Fair Randomness and Composite Seed Generation

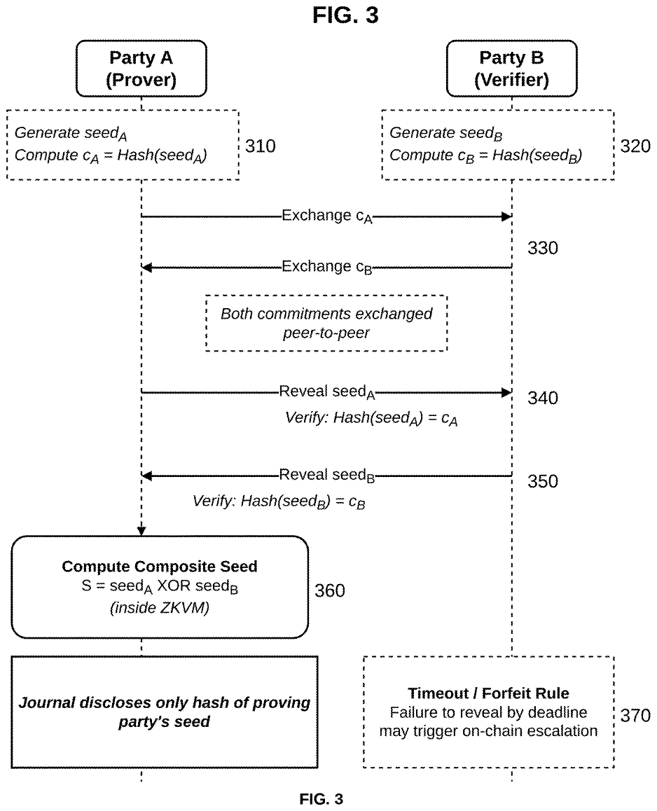

FIG. 3 illustrates an example commit-reveal protocol used to generate a composite seed. In one embodiment, each participant generates a seed component si using a cryptographically secure randomness source and transmits a seed component commitment ci=Commit(si) to the other participants (steps (310)-(320)). After all commitments are exchanged (step (330)) or after a commitment deadline, participants exchange their seed components (steps (340)-(350)), which are checked against the commitments.

A composite seed S is computed from the exchanged seed components using a deterministic combination function f that is commutative with respect to participant ordering, such as XOR, addition modulo a prime field, or a hash of a canonical concatenation of the seed components (step (360)). The use of multiple seed components ensures that if at least one party is honest and keeps its seed component unpredictable until exchange, the resulting S is unpredictable to adversaries at commitment time.

To deter selective aborts, the protocol may include timeouts (step (370)). For example, participants may optionally escalate to on-chain enforcement by locking collateral in a contract; failure to disclose a committed seed component by a deadline results in forfeiture or an automatic loss for purposes of the game session. In another embodiment, the protocol uses a verifiable delay function, a randomness beacon, or an externally verifiable entropy source as an additional seed component contributor.

In some embodiments, the composite seed is computed within a ZKVM guest program, and the proof journal outputs only a digest of the proving party's seed component rather than the raw seed component. Because the non-proving party cannot derive the composite seed from a hash alone, the composite seed is known only to the party executing the shuffle, preventing the counterparty from reconstructing the permutation. The commit-then-exchange ordering of seed component exchange prevents the shuffling party from adaptively choosing its seed component after learning the counterparty's seed component. In certain embodiments, the composite seed is used as an input to a cryptographically secure PRNG (for example, a ChaCha20-based stream generator) to derive per-step random values deterministically, such that the shuffle is fully determined by the two or more seed components and the disclosed shuffle algorithm. In alternative embodiments, a party may commit to the composite seed rather than to individual seed components, the proof journal may disclose a digest rather than a raw value of the non-proving party's seed component, or the composite seed may be disclosed after protocol completion for audit purposes, without altering the security guarantees during execution. In further embodiments, one or more seed components may be derived from an external verifiable entropy source, such as a distributed randomness beacon or a verifiable random function, in lieu of or in addition to a party-generated seed component, and the composite seed may be computed by combining the externally sourced entropy with any remaining party-contributed seed components using the deterministic combination function.

### 6. Deck Proofs and Shuffling Where Prover Knows Deck Order

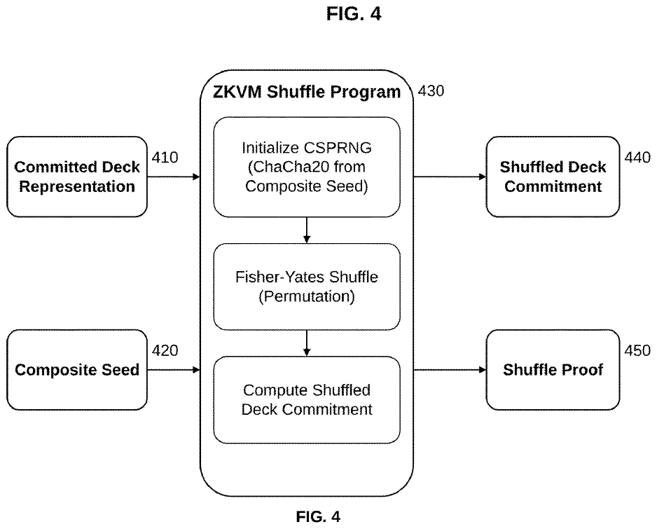

FIG. 4 illustrates an embodiment in which the prover knows the plaintext deck order during shuffle. The shuffle module receives a committed deck representation (410) and a composite seed (420). A ZKVM program (430) deterministically derives a sequence of random indices from the composite seed using a cryptographically secure PRNG and applies a shuffle algorithm (for example, a Fisher-Yates shuffle) to compute a permuted deck representation. In certain embodiments, shuffle indices are derived using an unbiased reduction method (for example, rejection sampling or modular reduction with bias correction) to ensure uniform distribution across the target range.

The ZKVM outputs a shuffled deck commitment (440) and a shuffle proof (450) attesting that the shuffled representation is a valid permutation of the input deck representation under the derived random indices. In one embodiment, the proof binds to public inputs including the original deck commitment and a commitment to the composite seed, and binds to outputs including the shuffled deck commitment.

To support later draw proofs, the shuffle program outputs a shuffled deck commitment (for example, a collision-resistant hash of the shuffled deck representation and a salt) that serves as a unique identifier binding the shuffled ordering to the proof transcript. A subsequent draw proof for a given deck position recomputes the deck identifier from the private shuffled deck and compares it to the previously accepted shuffle proof's deck identifier; a verifier rejects a draw proof whose deck identifier does not match.

### 6A. Deck Proofs and Shuffling With Commitment-Based Split Knowledge

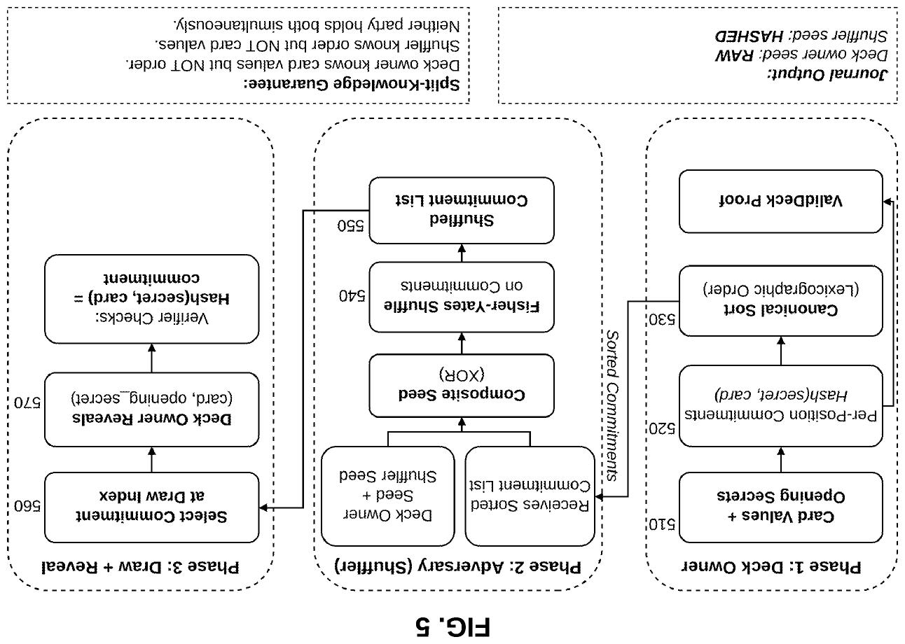

Referring now to FIG. 5, in an embodiment in which the deck owner should not learn the shuffled deck order, and the shuffling party should not learn card identities, a commitment-based split-knowledge protocol may be used. In this embodiment, each card in the deck is individually committed using a collision-resistant hash function applied to the card value and a per-card opening secret (510) (for example, Hash(opening_secret, card_value)). Each opening secret is generated independently using a cryptographically secure randomness source. The resulting per-position commitment digests (520) are sorted into a canonical order (530) (for example, lexicographic order) to remove any semantic ordering that might reveal information about the underlying card values.

A ZKVM program executed by the deck owner verifies that the deck satisfies ownership and ruleset constraints and that each per-position commitment is correctly computed from the corresponding card value and opening secret. The program outputs the sorted commitment list and a proof of correct computation, while keeping the card values and opening secrets private. The sorted commitment list is then provided to an adversarial counterparty for shuffling.

The counterparty, acting as the shuffling party, receives the sorted commitment list and executes a shuffle within a ZKVM. The shuffle program derives a composite seed from the shuffling party's seed component and the deck owner's seed component using a deterministic combination function, initializes a cryptographically secure PRNG from the composite seed, and applies a Fisher-Yates shuffle (540) to the commitment list. The shuffle program outputs the shuffled commitment list (550), a shuffled deck identifier computed from the shuffled list and a salt, and a digest of the shuffling party's seed component.

The proof journal of the shuffle proof discloses the deck owner's seed component in raw form (so the deck owner can verify its inclusion) and discloses only a digest of the shuffling party's seed component. Because the deck owner does not possess the shuffling party's raw seed component, the deck owner cannot derive the composite seed and therefore cannot reconstruct the permutation applied to the commitments. This structural separation ensures that no single party simultaneously possesses both the plaintext card values and the shuffled ordering, providing a protocol-level privacy guarantee that does not depend on the zero-knowledge property of the proof system.

When a draw is authorized at a given index, the shuffling party executes a draw program within a ZKVM that selects the per-position commitment at the specified index (560), recomputes the deck identifier to verify deck integrity, and outputs the selected commitment and deck identifier in a draw proof. The deck owner then reveals the drawn card (570) by providing the corresponding plaintext card value and opening secret. Any party may verify the reveal by checking that Hash(opening_secret, card_value) equals the commitment output by the draw proof. Opening secrets for undrawn positions remain confidential, preserving the unpredictability of subsequent draws.

In an alternative embodiment, the shuffling party does not execute a shuffle program within a zero-knowledge proving system. Instead, the deck owner first executes the deck verification program within the zero-knowledge proving system to produce per-position commitment digests that are attested by the deck composition proof as corresponding to a valid, ruleset-compliant deck. The shuffling party receives the per-position commitment digests output by the deck composition proof and selects a commitment at any position for each draw operation without generating a zero-knowledge shuffle proof. Because each per-position commitment digest is computed from an independent opening secret known only to the deck owner, and the deck composition proof attests that the commitments correspond to valid card values satisfying the ruleset constraints, the hiding property of the commitment scheme prevents the shuffling party from determining the card value associated with any selected commitment regardless of the order in which positions are selected. This approach reduces computational cost by eliminating the shuffle proof but may introduce information leakage if the commitment digests are provided in a structured order that correlates with card identity, and is therefore suitable for contexts in which the commitment scheme provides sufficient hiding guarantees.

### 7. Deck Proofs and Shuffling Where Prover Does Not Learn Final Deck Order

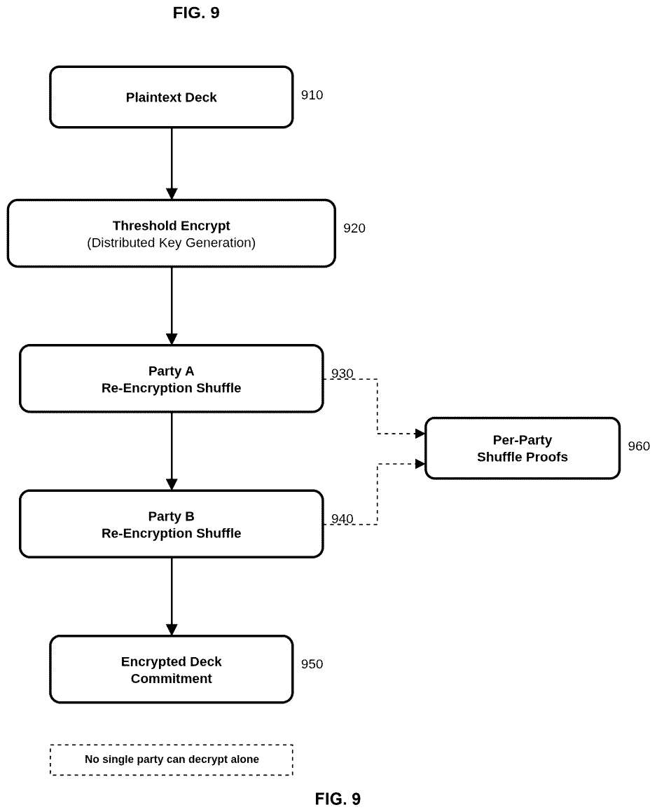

In shared-deck games and other embodiments, it may be undesirable for any single party, including a prover, to learn the final deck order before authorized reveals. FIG. 9 illustrates an embodiment using encryption and threshold decryption to prevent unilateral knowledge of deck order.

A plaintext deck (910) is first encrypted using a threshold encryption scheme (920). In one embodiment, cards are encrypted under layered encryption in which each of a plurality of parties applies its own encryption key sequentially, such that the resulting ciphertext can be decrypted only when all keys are applied in reverse. In another embodiment, cards are encrypted under a public key generated by distributed key generation among multiple parties, yielding a threshold decryption scheme. Each card ciphertext includes rerandomizable encryption (for example, ElGamal or other re-encryption-capable schemes) so that shuffles can be performed on ciphertexts while hiding plaintext card identities.

Each party performs a sequential re-encryption shuffle. A first party (Party A) applies a re-encryption shuffle (930) to the encrypted ciphertext list, permuting and re-randomizing each ciphertext, and produces a per-party shuffle proof (960) that the output ciphertext list is a re-encryption permutation of the input ciphertext list without revealing the permutation. A second party (Party B) then applies a further re-encryption shuffle (940) to the resulting ciphertext list and produces an additional per-party shuffle proof (960). Such shuffle proofs may be implemented as mixnet shuffle proofs, ZKVM-executed proofs, or circuit-based proofs.

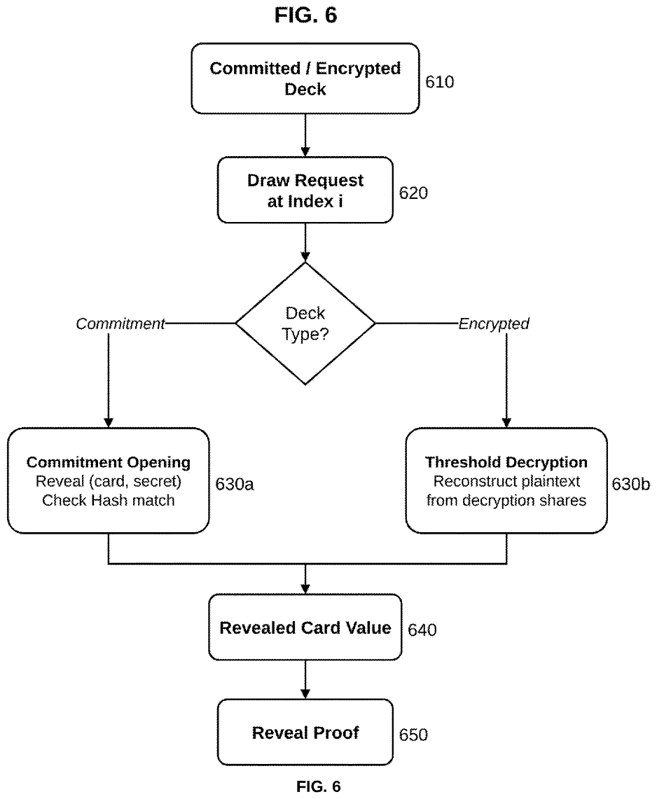

After one or more re-encryption shuffles, the resulting encrypted deck commitment (950) is recorded, and no single party can decrypt any position alone. When a draw is authorized, threshold decryption reconstructs the plaintext card for the selected position and optionally produces a proof that the decrypted plaintext corresponds to the committed ciphertext at that position (see FIG. 6).

Optional use of oblivious transfer. In some embodiments, the system uses an oblivious transfer protocol instead of, or in addition to, threshold decryption. A party authorized to draw a card acts as a receiver in a 1-out-of-N oblivious transfer over N committed card representations, such that the receiver obtains only decryption material for a selected position while (i) a sender learns no information about which position was selected and (ii) the receiver obtains no information enabling decryption or opening of non-selected positions.

In embodiments using threshold encryption, the oblivious transfer may deliver a sufficient subset of decryption shares for a selected ciphertext without disclosing shares for other ciphertexts. The draw operation may include generating a zero-knowledge proof that the obtained decryption material opens or decrypts the committed card at the selected index and that the deck commitment is updated by removing or marking the selected index as drawn, without revealing card values or order for unrevealed indices.

### 8. Progressive Reveal and Draw Operations

FIG. 6 illustrates a draw operation. A committed or encrypted deck element (610) at index i of a committed shuffled deck is selected for reveal. At step (620), a participant requests a draw at index i. In an embodiment where the deck is maintained as commitments, the system opens the commitment at index i by revealing the committed card value and its opening secret (630a). In an embodiment where the deck is encrypted, the system performs threshold decryption (630b) of the ciphertext at index i. In either case, the system outputs the revealed card value (640).

In either embodiment, a reveal proof (650) is generated to prove that the revealed value corresponds to the committed deck position. For example, the proof may show that Hash(value, opening_secret) equals the per-position commitment at index i, and that the per-position commitment list is consistent with the deck commitment.

In some embodiments, the draw operation reveals only the card value and opening secret for the selected position, while commitments for all other deck positions remain unopened. A verifier confirms that the revealed card matches the commitment at the selected index and that the deck identifier is consistent with the previously accepted shuffle proof, without gaining information about unrevealed positions.

### 9. Game State Transitions, Interactive Composite Proofs, and Dispute Resolution

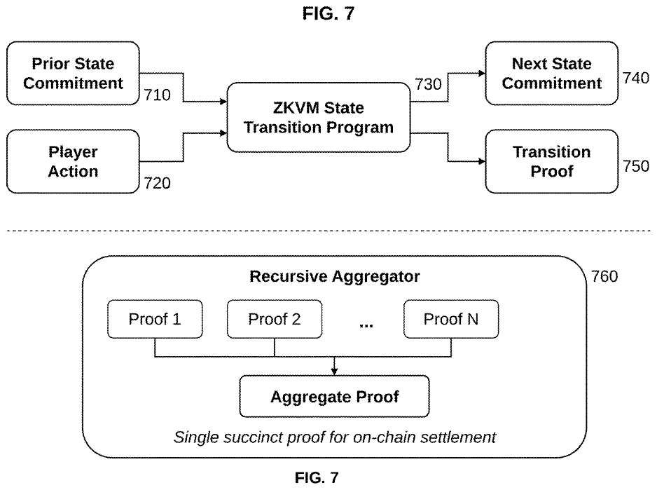

FIG. 7 illustrates state transition proofs. A game state is represented as a structured state object that is committed to as a state commitment, for example using a Merkle root, Poseidon hash chain, or other collision-resistant commitment scheme. A prior state commitment (710) and a player action (720), which may include both public components (for example, a declared move) and private components (for example, a committed selection from a hand), are provided as inputs to a state transition program.

A ZKVM state transition program (730) applies the game rules to the prior state commitment (710) and the player action (720) to compute a next state commitment (740) and emits a transition proof (750) that the transition is rule-compliant. The public inputs may include the prior state commitment, action commitments, and any public randomness commitments; the public outputs may include the next state commitment and, optionally, settlement outputs. Successful verification of at least one of the transition proof or a shuffle proof authorizes a verified finalization of the next committed game state.

In interactive composite embodiments, multiple parties provide interdependent commitments or partial proofs such that no single party can unilaterally bias the transcript. For example, a state transition program may incorporate challenge values derived from commitments submitted by multiple parties, and the final proof binds to a transcript commitment that includes each party's contribution.

Dispute resolution and liveness may be achieved by on-chain deadlines, forfeiture of escrowed stakes, or adjudication rules in which a party can force progress by submitting a proof of its own compliance together with evidence of the other party's noncompliance (for example, failure to reveal a seed or failure to submit a required action commitment).

In certain embodiments, intermediate state transitions during gameplay are exchanged peer-to-peer between the parties and verified locally by each party's verifier without recording to a distributed ledger. Each party may provide evidence of acceptance of a received state transition, for example by transmitting a subsequent player action that references the prior committed game state, or by providing a cryptographic signature over the prior committed game state. At game conclusion, the system submits a final state proof together with evidence of counterparty acceptance to a verifier smart contract for settlement. Because the verifier smart contract validates only the final state proof and acceptance evidence, on-chain verification cost is independent of the number of intermediate state transitions that occurred during the game session.

In certain embodiments, the peer-to-peer exchange of intermediate state transitions is conducted through one or more relay nodes that forward messages between parties. The relay nodes can mask the network addresses of the participating parties from each other, providing transport-level privacy while preserving the cryptographic guarantees of the state transition protocol. Because the exchanged messages comprise zero-knowledge proofs and committed state values, the relay nodes do not learn private game-input data or secret key material from the forwarded messages.

In certain embodiments, either party may escalate to on-chain enforcement at any point during the game session by submitting to a verifier smart contract a zero-knowledge proof of the current committed game state. Upon receiving the escalation proof, the smart contract requires the opposing party to submit a valid state transition proof advancing the game state before a deadline. Failure to submit the required proof by the deadline triggers a forfeit condition enforced by the smart contract. This escalation mechanism ensures liveness without requiring all intermediate state transitions to be recorded on-chain, as on-chain enforcement is invoked only when a party is unresponsive or noncompliant.

### 10. Recursive Proof Aggregation and Final Settlement

As shown in FIG. 7, a recursive aggregator (760) may aggregate multiple transition proofs into a single proof that attests to an entire sequence of state transitions from an initial state to a final state. Recursive aggregation reduces verification cost on a distributed ledger by allowing verification of a single succinct proof rather than N individual proofs.

In one embodiment, each move proof is verified inside a recursive circuit or ZKVM program, and the aggregator outputs a final proof whose public inputs include an initial game identifier and initial state commitment and whose public outputs include a final state commitment and settlement instructions (for example, asset transfers). In an alternative embodiment, recursive aggregation of all prior proofs may be deferred using optimistic verification: when a party submits a subsequent action that depends on a prior committed game state, the submission of the subsequent action constitutes an implicit acceptance of the correctness of the prior state transition, and full recursive verification is required only for disputed state transitions. A party that believes a prior state transition was incorrect may initiate a dispute by submitting a challenge together with a proof of the claimed correct state, triggering on-chain adjudication. This optimistic approach reduces verification cost by requiring proof aggregation and on-chain verification only when state transitions are contested, while the mere continuation of gameplay by both parties provides practical assurance that prior states were accepted as valid.

### 11. Verifiable Randomness for Non-Deck Game Events

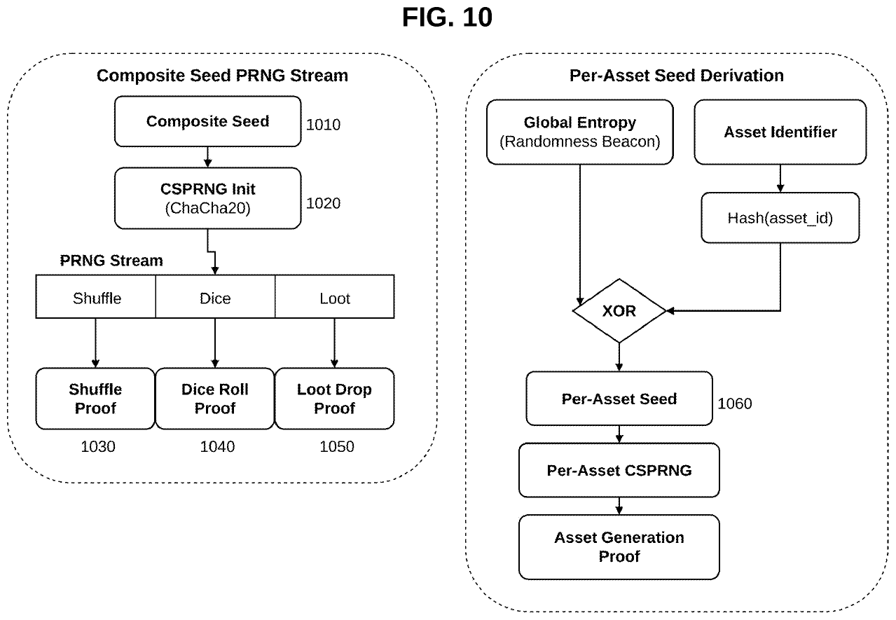

Referring now to FIG. 10, the composite seed protocol may be used not only for shuffling but also for other stochastic events such as dice rolls, random loot drops, procedural generation, matchmaking randomness, or randomized targeting. In such embodiments, a ZKVM program consumes a composite seed (1010) and deterministically derives random outputs using a secure PRNG, proving that the derived random outputs were computed according to the specified algorithm and were incorporated into the state transition correctly.

Because the composite seed initializes a cryptographically secure pseudorandom number generator (1020) having internal state that advances with each consumption of random output, a single seed establishment ceremony may support multiple sequential randomized operations within one or more zero-knowledge proofs. Each proof attests that its randomized operations consumed the correct segment of the pseudorandom stream derived from the committed composite seed, without revealing the seed value or the internal state of the generator. For example, a first proof may consume an initial segment of the stream to perform a shuffle (1030), and a subsequent proof may consume a next segment of the same stream to determine a dice outcome (1040) or other stochastic event such as a loot drop (1050), with each proof independently verifiable against the same seed commitment.

In certain embodiments, the verifiable randomness and zero-knowledge proof techniques disclosed herein are applied to any process involving digital assets whose allocation, attributes, or ordering are determined by a non-uniform probability distribution, including but not limited to collectible item distribution, game reward allocation, procedural content generation, randomized access or priority assignment, loot distributions, and crafting outcome determination, wherein a proving system generates a proof that the probabilistic allocation was computed faithfully according to a disclosed probability model without revealing private inputs to the allocation process.

For example, in one embodiment, a randomized asset distribution event such as a booster pack opening uses a verifiable external entropy source (for example, a distributed randomness beacon) combined with a per-asset identifier to produce a deterministic per-item seed. A zero-knowledge virtual machine program or other zero-knowledge proving system (for example, a ZKVM, a specialized zero-knowledge circuit, or a hybrid proving pipeline) consumes the verified entropy, applies a probability distribution model to determine item attributes (for example, rarity tiers with defined probability thresholds and visual characteristics assigned via independent probability checks per attribute), and outputs a commitment to the resulting item allocations (for example, a Merkle root over the allocated items). An on-chain verifier validates the ZKVM proof and processes item claims via inclusion proofs anchored to the committed allocation root, enabling paginated claim operations for large distributions without re-verification of the proof.

In certain embodiments, a per-asset seed (1060) is derived by combining a global entropy value with a per-asset identifier using a domain-separated construction (for example, asset_seed=GlobalEntropy XOR Hash(asset_identifier)), ensuring that each asset receives unique, deterministic randomness while preventing cross-asset prediction from a single revealed outcome. The global entropy may be obtained from a distributed randomness beacon, from a commit-reveal protocol among participants, or from another externally verifiable entropy source.

### 12. Applicability to Game Genres and Execution Environments

The disclosed techniques are applicable to game genres including but not limited to TCGs/CCGs, poker-like games, board games with hidden tiles, role-playing games with hidden inventories, strategy games with fog-of-war information, and games with randomized events. The disclosed techniques are also applicable beyond gaming to any adversarial process requiring verifiable randomness and privacy-preserving state transitions.

The disclosed system may operate with smart contract platforms including Ethereum-compatible virtual machines, rollup environments, application-specific chains, or other distributed ledgers. Proof verification may occur fully on-chain, partially on-chain with fraud proofs, or off-chain with on-chain settlement of final state commitments.

### 13. Implementation Details and Examples

ZKVM implementations may include RISC Zero, SP1, Cairo, zkEVM variants, Noir-based systems, Leo, or other proving systems. Hash functions may include SHA-256 for broad hardware acceleration, Poseidon for constraint efficiency, Keccak-256 for EVM compatibility, Blake3 for off-chain performance, or other collision-resistant hashes.

In one example embodiment for a TCG match, each player proves deck validity against on-chain ownership, parties generate a composite seed, the deck is shuffled with a shuffle proof, and each draw produces a reveal proof and updates a committed game state. Each move is proved as a state transition and the sequence is aggregated for final settlement.

In another example embodiment for a dice-based game, players commit seed components, exchange to form a composite seed, a ZKVM computes dice outcomes from the composite seed, and a state transition proof attests to correct use of the dice outcomes in applying game rules.

### 14. Security Considerations

The system is designed to resist deck manipulation (inclusion of unowned assets or illegal compositions), shuffle manipulation (biased or predictable shuffles), draw manipulation (selective reveals or unauthorized knowledge of unrevealed positions), state manipulation (invalid moves or illegal state transitions), and denial-of-service or griefing (selective aborts in commit-reveal or refusal to participate).

Security depends on standard cryptographic assumptions of the employed primitives, including collision resistance of commitment hashes, soundness and zero-knowledge properties of the proving system, and security of threshold encryption where used. The disclosed forfeiture and timeout mechanisms provide economic deterrence to abort-based bias attempts in multi-party randomness generation.

### 15. Appendix (Example ZKVM Implementations and Implementation-Grade Pseudocode)

### 15.1 Example ZKVM Implementation a (Known-Order Prover Design)

This Appendix describes non-limiting example implementations prototyped using a zero-knowledge virtual machine (ZKVM) toolchain such as RISC Zero. In such implementations, a guest program executes deterministically over a defined input schema and commits a defined output schema to a journal. A host program verifies a receipt against a guest program image identifier generated from the guest code, and parses the journal to obtain the committed outputs. The guest executable (Executable and Linkable Format, or ELF) and image identifier are produced by the ZKVM build process from the guest source code and are treated as binding identifiers for verification.

In a known-order prover design, a prover holds plaintext deck values and produces a proof that the deck satisfies ruleset constraints and that a shuffled deck identifier is derived deterministically from a composite seed. This design supports verifiable shuffling and verifiable draws in embodiments in which confidentiality against the prover is not required.

Example guest input and output structures include: DeckShufflerInput={cards, deck, salt, player_seed, adversary_seed} and DeckShufflerOutput={cards, deck_commitment, player_seed_hash, adversary_seed, deck_id}. Here, cards is a sorted list of allowable Card values, deck is a sorted list of selected Card values, salt is a commitment secret, player_seed is the prover's seed component, and adversary_seed is the counterparty's seed component. The output includes a deck_commitment committing to the pre-shuffle deck, a player_seed_hash (a digest of the prover's seed component), and a deck_id committing to the shuffled deck.

In one prototype, a deck commitment Commit(salt, message) is computed by deterministically serializing message and hashing the concatenation of salt and the serialized bytes. In another prototype, a two-stage keyed hash is used that hashes (salt∥message) to obtain an inner digest and then hashes (salt∥inner_digest) to obtain the final digest. Either construction yields a binding commitment under standard hash assumptions and is used to bind deck content and ordering to the proof transcript.

In one prototype, the composite seed is computed as composite_seed[i]=player_seed[i] XOR adversary_seed[i] for i from 0 to 31. A cryptographically secure pseudorandom number generator (PRNG), for example ChaCha20 seeded by composite_seed, drives a Fisher-Yates shuffle to compute a permutation of the deck. The shuffle is deterministic given the two seed components and the disclosed shuffle algorithm.

In one prototype deck-validation-and-shuffle guest program, the guest enforces: (i) deck length bounds (for example, at least 60 and at most 120), (ii) cards and deck are sorted in non-decreasing order, and (iii) deck is a multiset subset of cards (including correct handling of duplicates). The guest computes player_seed_hash=H(player_seed), computes deck_commitment=Commit(salt, deck), computes shuffled_deck=Shuffle(deck, player_seed, adversary_seed), computes deck_id=Commit(salt, shuffled_deck), and commits to the journal an output structure containing at least {cards, deck_commitment, player_seed_hash, adversary_seed, deck_id}.

In one prototype draw guest program, the guest receives DrawCardInput={deck, index, salt} where deck is the shuffled plaintext deck vector. The guest checks index bounds, computes deck_id=Commit(salt, deck), selects card=deck[index], and commits DrawCardOutput={card, index, deck_id} to the journal. A verifier rejects a draw receipt whose deck_id does not match the deck_id of the previously accepted shuffle receipt for the same round.

In one prototype host program, a prover executes the guest programs to obtain receipts. A verifier parses the journal outputs and checks them against session context recorded out-of-band, for example in a peer-to-peer session log. In an alternative embodiment, session context may be recorded on a ledger. For example, the verifier checks that player_seed_hash equals a previously recorded seed component commitment, checks that adversary_seed equals the counterparty's seed component for the round, checks that deck_commitment equals a previously recorded deck commitment, and then verifies the receipt against the guest image identifier. Upon successful verification, the verifier accepts deck_id as the committed identifier of the shuffled deck for subsequent draw proofs.

### 15.2 Example ZKVM Implementation B (Secret Deck Commitment Design)

In a secret deck commitment design, the deck is represented as a list of per-position commitment digests rather than plaintext Card values. Each commitment digest binds a plaintext Card value to a corresponding opening secret. This representation supports protocols in which a draw may return only a commitment token for the selected position, and a later reveal discloses the underlying plaintext Card value and opening secret for that position.

Example guest input and output structures include: ValidDeckInput={cards, deck, opening_secrets} and ValidDeckOutput={cards, deck_commitments}; DeckShufflerInput={player_seed, adversary_seed, salt, deck_commitments} and DeckShufflerOutput={deck_commitments, player_seed, adversary_seed_hash, deck_id}; and DrawCardInput={deck_commitments, index, salt} and DrawCardOutput={card_commitment, index, deck_id}.

In one prototype valid-deck guest program, the guest enforces: (i) deck length bounds, (ii) cards and deck are sorted, (iii) deck is a multiset subset of cards, and (iv) opening_secrets length equals deck length. The guest then computes deck_commitments[j]=Commit(opening_secrets[j], deck[j]) for each position j. The guest sorts deck_commitments into a canonical order (for example, lexicographic order of commitment digests) and commits ValidDeckOutput to the journal. Canonical sorting allows a counterparty to apply further shuffles without learning any semantic ordering from the prover-provided ordering of plaintext cards.

In one prototype shuffle guest program, the guest receives a canonical, pre-sorted deck_commitments list and verifies that it is sorted. The guest derives a composite seed from player_seed and adversary_seed, initializes a PRNG from the composite seed, applies a Fisher-Yates shuffle to deck_commitments, computes deck_id=Commit(salt, shuffled_commitment_list), computes adversary_seed_hash=H(adversary_seed), and commits DeckShufflerOutput to the journal. Selective disclosure of only adversary_seed_hash enables verification of the shuffling party's seed component commitment without requiring disclosure of the raw seed component, as the zero-knowledge proof attests to correct usage of the committed seed component. The commit-then-exchange ordering of seed component exchange prevents the shuffling party from adaptively choosing its seed component after learning the counterparty's seed component.

In one prototype draw guest program for secret decks, the guest receives the shuffled commitment list, checks index bounds, selects card_commitment=deck_commitments[index], computes deck_id=Commit(salt, deck_commitments), and commits DrawCardOutput to the journal. A later reveal for a selected position may provide plaintext_card and opening_secret together with a check that Commit(opening_secret, plaintext_card) equals card_commitment. The reveal may be done as an on-chain check, an off-chain check, or as a separate ZK proof that the revealed plaintext matches the selected commitment while other commitments remain hidden.

In certain embodiments, secret deck commitment designs are extended to multi-party shared decks by replacing per-position commitment digests with ciphertext tokens or rerandomizable commitments. Each shuffle step is accompanied by a zero-knowledge proof that the output token list is a permutation, and where applicable a re-randomization, of the input token list. Selective reveal is achieved by threshold decryption for a selected position, by oblivious transfer, or by another disclosed selective reveal mechanism, while preventing disclosure of non-selected positions.

### 15.3 Implementation-Grade Pseudocode for Additional Non-Limiting Embodiments

Deterministic draw index derivation: In certain embodiments, the draw index is not chosen by a prover. Compute digest=H(domain_sep∥round_id∥event_counter∥composite_seed∥prior_state_digest∥deck_id). Then compute idx=ReduceUniform(digest, deck_len), where ReduceUniform maps a fixed-width digest to an unbiased integer in [0, deck_len-1] using rejection sampling or another disclosed unbiased reduction method. The inputs are public and bound to the transcript so any verifier can recompute idx. In other embodiments, the draw index is provided as a public input to the draw program by a requesting party, by game rules (for example, sequential draws from a deck top), or by any other index selection mechanism. The draw proof is independent of the index selection method; it attests that the card or commitment at the specified index corresponds to the committed shuffled deck.

Chained deck update to prevent replacement: In certain embodiments, after a draw at idx, compute next_list by removing the token at idx or replacing it with a tombstone token. Compute next_deck_id=Commit(salt, next_list). The draw proof attests that next_list is derived from the input list by the disclosed update rule. Subsequent draw proofs require that the input deck_id equals the last accepted next_deck_id for the round. In other embodiments, the deck list and deck identifier remain unchanged across multiple draws within a round, and draw integrity is maintained by verifying that each draw proof's deck identifier matches the accepted shuffle proof's deck identifier for the same round.

Ownership-constrained deck membership: In certain embodiments, for each referenced token_id in a deck, verify within the ZKVM that token_id is owned by a player address under a public ledger root. An example predicate is VerifyMerkleInclusion(token_id, owner, ledger_root, merkle_path) for each token_id, and the deck composition proof attests that all cards in the deck correspond to owned tokens under the ledger root and the ruleset constraints.

Commit-reveal liveness and penalties: In certain embodiments, seed component commitments are exchanged peer-to-peer and verified locally by each party against a commitment deadline. In an alternative embodiment, a ledger-resident state machine may record seed component commitments and enforce the exchange deadline on-chain. If a party fails to disclose a committed seed component before the deadline, the ledger applies a penalty rule that may include forfeiture of stake, default loss, or exclusion from the round. The composite seed is computed as a deterministic function of all exchanged seed components and a round context string to prevent replay across rounds.

Recursive aggregation for settlement: In certain embodiments, per-move receipts are aggregated to reduce settlement cost. An example aggregator verifies a prior aggregate receipt inside a ZKVM, verifies a new move receipt, and outputs a new aggregate receipt binding a new state digest. A verifier then verifies only the final aggregate receipt and compares the final state digest to settlement parameters.

### 16. Computing Environment

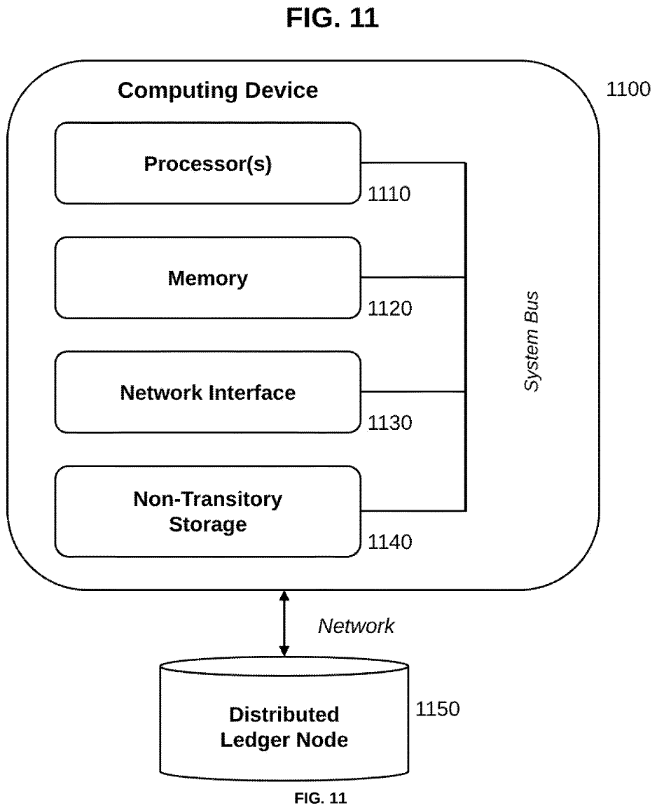

Referring now to FIG. 11, a computing device (1100) suitable for implementing the disclosed system includes one or more processors (1110), memory (1120) coupled to the processors, a network interface (1130) for communicating with remote systems including distributed ledger nodes, and non-transitory storage (1140) storing instructions that, when executed by the processors, cause the computing device to perform the methods described herein. The computing device (1100) communicates via the network interface (1130) with at least one distributed ledger node (1150) to submit proofs, read ownership state, and settle game outcomes. The computing device (1100) may be any suitable computing system, including a personal computer, server, mobile device, or cloud computing instance.

What is claimed is:

1. A computer-implemented method implementing a cryptographic verification protocol for verifying rule-constrained state transitions having hidden inputs between mutually distrustful parties, the method comprising:
(a) executing, by a prover computing system within a zero-knowledge proving system, a deck verification program that receives, as a public input, a ruleset identifier and receives, as private inputs, a candidate plurality of card values and associated openings, and that generates (i) a deck commitment committing to the plurality of card values and (ii) a zero-knowledge deck composition proof attesting that the plurality of card values satisfies deck-building constraints of the ruleset;
(b) recording or exchanging the deck commitment and one or more seed component commitments provided by the parties;
(c) generating an adversarially fair composite seed by receiving corresponding seed components for the seed component commitments and computing the composite seed from the seed components according to a deterministic combination function;
(d) executing, by the prover computing system within the zero-knowledge proving system, a shuffle program that receives, as a public input, the deck commitment, derives the composite seed from the seed components according to the deterministic combination function, receives, as private inputs, openings for the deck commitment, derives a permutation from the composite seed under a deterministic derivation rule, applies the permutation to the committed plurality of card values to compute a shuffled deck commitment, and generates a zero-knowledge shuffle proof attesting that the shuffled deck commitment corresponds to a valid permutation of the deck commitment;
(e) responsive to authorization of a draw operation, executing, by the prover computing system within the zero-knowledge proving system, a draw program that receives a draw index identifying a position in the shuffled deck, verifies that the draw index is within bounds of the shuffled deck, verifies consistency of the shuffled deck commitment with the shuffled deck commitment from the shuffle proof, and generates a zero-knowledge reveal proof attesting that a revealed card value or card commitment corresponds to the draw index without revealing other card values or commitments; and
(f) verifying, by a verifier, the deck composition proof, the shuffle proof, and the reveal proof, and recording at least the shuffled deck commitment and the revealed card value or card commitment for subsequent verification or settlement.

2. The method of claim 1, wherein the deck verification program further receives, as a public input, a public ownership commitment and verifies that the plurality of card values corresponds to assets verifiable against the public ownership commitment.

3. The method of claim 2, wherein the deck verification program verifies that the plurality of card values corresponds to owned tokenized assets by validating Merkle inclusion proofs anchored to the public ownership commitment.

4. The method of claim 2, wherein the public ownership commitment comprises a distributed-ledger state root and the deck verification program validates inclusion proofs anchored to the distributed-ledger state root.

5. The method of claim 1, wherein computing the composite seed comprises applying at least one of: bitwise XOR of the seed components, addition of the seed components modulo a prime field, or hashing a canonical concatenation of the seed components.

6. The method of claim 1, wherein the shuffle program implements a Fisher-Yates shuffle and derives shuffle indices using a cryptographically secure pseudorandom number generator seeded by the composite seed.

7. The method of claim 1, wherein the shuffle proof attests that a list of per-position commitments associated with an input deck is in a canonical order prior to shuffling, and that an output deck commitment corresponds to a permutation of the canonical list under a permutation derived from the composite seed.

8. The method of claim 1, wherein the deck commitment comprises a plurality of per-position commitment digests, each computed from a card value and an independent opening secret, and wherein the per-position commitment digests are arranged in a canonical order prior to shuffling.

9. The method of claim 8, wherein the shuffle program is executed by a shuffling party other than a deck owner of the plurality of card values, and wherein a proof journal includes a digest of the shuffling party's seed component and a raw value of the deck owner's seed component, such that the deck owner can verify inclusion of its seed but cannot derive the composite seed.

10. The method of claim 8, wherein the draw operation outputs a per-position commitment digest for a selected index, and wherein revealing the drawn card comprises disclosing the corresponding card value and opening secret such that a verifier can confirm that applying a commitment function to the disclosed card value and opening secret yields the per-position commitment digest.

11. The method of claim 1, further comprising encrypting card values under a threshold public key such that no single party can decrypt unrevealed card values, and wherein the shuffled deck commitment is a commitment to an encrypted deck.

12. The method of claim 11, further comprising performing at least one re-encryption shuffle on ciphertexts by at least one party and generating a zero-knowledge shuffle proof that an output ciphertext list is a re-encryption permutation of an input ciphertext list without revealing a permutation mapping.

13. The method of claim 11, wherein executing a draw operation comprises threshold-decrypting a ciphertext at a selected deck index and generating a reveal proof that a revealed plaintext corresponds to the ciphertext at the selected deck index within the encrypted deck.

14. The method of claim 1, further comprising updating the shuffled deck commitment after each draw operation by removing or marking the drawn position, and wherein subsequent draw proofs verify consistency with the updated deck commitment.

15. The method of claim 1, wherein the draw index is provided as a public input by a requesting party or determined by game rules.

16. The method of claim 1, wherein a single establishment of the composite seed initializes a deterministic pseudorandom number generator, and wherein multiple zero-knowledge proofs each attest to correct consumption of a respective segment of the pseudorandom stream derived from the composite seed, such that a single seed ceremony supports multiple independently verifiable randomized operations.

17. The method of claim 1, wherein the zero-knowledge proving system executes a general-purpose instruction set.

18. The method of claim 1, wherein verification is performed by a verifier smart contract executing on a distributed ledger, and wherein the verifier smart contract authorizes state finalization only upon successful proof verification.

19. A cryptographic game-execution system comprising: one or more processors; non-transitory memory storing instructions; and a zero-knowledge proving system configured, when the instructions are executed, to:
(a) verify, with respect to a public ownership commitment, that private game-input data satisfies ownership and ruleset constraints, and output a commitment bound to the private game-input data;
(b) validate seed component commitments and seed components from at least two adversarial parties and compute a composite seed;
(c) compute a permuted representation of the private game-input data based on pseudorandom values derived from the composite seed and generate a shuffle proof attesting to correctness of the permutation; and
(d) compute a next committed game state from a prior committed game state and a player action and generate a state transition proof, wherein a verifier verifies at least one of the shuffle proof or the state transition proof to authorize a verified finalization of the next committed game state.

20. The system of claim 19, further comprising a distributed ledger interface configured to submit proofs to a verifier smart contract and to read at least one of an ownership root, a game state commitment, or an escrow state from the distributed ledger.

21. The system of claim 19, further comprising a recursive proof aggregation module configured to aggregate a plurality of state transition proofs into a single proof whose verification attests to correctness of a sequence of state transitions.

22. The system of claim 19, wherein per-asset randomness is derived by combining the composite seed or a global entropy value with a per-asset identifier using a domain-separated construction, such that each asset receives unique deterministic randomness and disclosure of one asset's random value does not reveal randomness for other assets.

23. The system of claim 20, wherein the distributed ledger interface enforces liveness using at least one of timeouts, escrowed stakes, or adjudication rules that penalize a party for failure to provide a required commitment, reveal, or proof.

24. The system of claim 19, wherein the public ownership commitment represents token balances according to at least one of ERC-20, ERC-721, or ERC-1155 standards or an equivalent token accounting model on a non-EVM ledger.

25. The system of claim 19, wherein the state transition proof proves correct application of at least one randomized event selected from: a dice roll, a loot drop, a procedural content generation event, or a randomized targeting event.

26. The system of claim 19, wherein a subsequent player action submitted by a party that received a prior state transition proof constitutes an implicit acceptance of the prior committed game state, and wherein recursive proof aggregation of the prior state transition proof is deferred unless a dispute challenge is submitted by a party, such that verification cost is reduced by requiring proof verification only for disputed state transitions.

27. The system of claim 19, wherein intermediate state transitions between a game-start commitment and a final game state are exchanged peer-to-peer and verified locally by each party, and wherein the system settles the final game state on a distributed ledger by submitting a final state proof together with evidence of counterparty acceptance, such that on-chain verification cost is independent of the number of intermediate state transitions.

28. The system of claim 27, wherein either party may escalate to on-chain enforcement by submitting to a verifier smart contract a zero-knowledge proof of a current committed game state, thereby requiring the other party to submit a valid state transition proof before a deadline enforced by the smart contract, and wherein failure to submit the required proof by the deadline triggers a forfeit condition.

29. A non-transitory computer-readable medium storing instructions that, when executed by one or more processors, cause a computing system to perform the method of claim 1.

30. The non-transitory computer-readable medium of claim 29, wherein the instructions include a ZKVM-executable shuffle program that outputs a shuffled deck commitment and a shuffle proof bound to a public commitment of a composite seed.

31. The non-transitory computer-readable medium of claim 29, wherein the instructions implement a shared-deck protocol that includes threshold encryption of card values, at least one verifiable re-encryption shuffle, and progressive reveal using at least one of
(i) threshold decryption or
(ii) oblivious transfer that provides decryption material for a selected card index without providing decryption material for non-selected card indices.

32. A computer-implemented method for cryptographically verifiable shuffling of hidden inputs between a first party and a second party, the method comprising:
(a) representing, by the first party within a zero-knowledge proving system, a set of input elements as a plurality of per-position commitment digests, each per-position commitment digest computed from a respective input element value and an independent opening secret, and arranging the per-position commitment digests in a canonical order;
(b) providing the canonically ordered per-position commitment digests to the second party;
(c) executing, by the second party within a zero-knowledge proving system, a shuffle program that derives a composite seed from a first seed component of the second party and a second seed component of the first party using a deterministic combination function, applies a permutation derived from the composite seed to the per-position commitment digests to produce a shuffled deck identifier, and generates a shuffle proof, wherein a proof journal of the shuffle proof discloses a digest of the second party's first seed component and a raw value of the first party's second seed component;
(d) responsive to authorization of a selection at a specified index, executing within the zero-knowledge proving system a draw program that outputs the per-position commitment digest at the specified index and a selection proof verifying consistency with the shuffled deck identifier; and
(e) revealing, by the first party, the input element value and opening secret corresponding to the selected per-position commitment digest, enabling verification that the revealed input element value and opening secret produce the selected per-position commitment digest.

33. The method of claim 32, wherein the digest of the second party's first seed component prevents the first party from reconstructing the permutation applied to the per-position commitment digests, and the raw value of the first party's second seed component enables the first party to verify that its seed component was correctly incorporated into the composite seed.

34. The method of claim 1, wherein at least one seed component is obtained from an external verifiable entropy source comprising a distributed randomness beacon or a verifiable random function output, and wherein the composite seed is computed by combining the externally sourced entropy value with at least one party-contributed seed component using the deterministic combination function.
